(19) United States
(12) Patent Application Publication
(10) Pub. No.: US 2003/0103724 A1
(43) Pub. Date: Jun. 5, 2003

(54) High power optical fiber coupling

(76) Inventors: Gary S. Duck, Ottawa (CA); Derwyn Johnson, Ontario (CA)

Correspondence Address: JDS Uniphase Corporation, Intellectual Property Dept., 3000 Merivale Road, Ottawa, ON, K2G 6N7, CA

(21) Appl. No.: 10/266,600

(22) Filed: Oct. 9, 2002

(30) Foreign Application Priority Data
Dec. 5, 2001 (CA) 2,364,437

(51) Int. Cl. G02B 6/32

(52) U.S. Cl. 385/33

(57) ABSTRACT

An optical coupling is useful for lessening negative effects associated with launching high power signals from a single mode optical fiber. The coupling has a mono-mode optical fiber fused axially to a second optically homogeneous glass fiber having no core and no optical power, the latter fiber dimensioned such that light propagating from the optical fiber's core diverges and passes rectilinearly therethrough without touching the side walls of the second fiber. The second fiber is optically coupled with a GRIN lens. Typically, the mono-mode fiber and the second fiber have the same diameter and are mounted in a ferrule.

### CROSS-REFERENCE TO RELATED APPLICATIONS

This application claims priority from Canadian Patent Application No. 2,364,437 filed Dec. 5, 2001 for the present invention.

### FIELD OF THE INVENTION

This invention relates generally to the coupling of an optical fiber with one or more components, and more particularly relates to using a special optical fiber that will permit high power optical signals to be launched therefrom lessening negative effects normally associated with launching very high power signals from a single mode optical fiber.

### BACKGROUND OF THE INVENTION

Fiber ends are susceptible to contamination or abrasion. Various prior art patents address the issue and attempt to provide solutions to reduce the amount of contamination from dirt, moisture, debris, grease, and other contaminants, however this problem continues to exist. In fact, as of late, the effects of contaminants on an end face surface of an optical fiber connector have become an increasingly larger problem than in the past. This is due in part to the fact that high power optical signals are becoming more commonplace with an increased use of rare-earth doped optical fiber amplifiers and the use of wavelength multiplexing. A link carrying 10 wavelength channels will typically have 10 times the average power as a link with only one wavelength channel.

Currently, systems are available having 100 or more wavelength channels. As well, the problem of dirt and debris present at the fiber end face is becoming increasingly more serious with recent requirements to use optical fibers having a small core diameter, i.e. in the range of 6 microns or less in the construction of optical amplifiers. An impetus for utilizing a fiber of this type, having a small mode field diameter (MFD), is a high power density that is desirable in (e.g. erbium) doped amplifying optical fiber. However, high power optical energy propagating within a small MFD produces an optical power density at a fiber end face that can result in damage that would not occur at lower power densities.

The damage mechanism has a very nonlinear dependence on light power. When debris is present at an end face of an optical fiber, it can absorb light significantly so that eventually the heated particles scorch, pit, and damage the end face of the optical fiber, rendering it useless for further transmission. The damage to the optical fiber end in some instances is so severe that it is believed that these contaminant particles actually explode in the presence of sufficient concentrated light energy. This problem is known to exist in standard single mode optical fiber having a MFD of about 10 μm with optical signals having more than 200 milliwatts of power, and is yet more damaging in instances where these or higher power optical signals are concentrated in a smaller core diameter optical fiber. Currently, there are requirements to provide optical couplings wherein light of as much as 1 W of power is transmitted. Even with taking all possible precautions, and attempting to ensure that the end face of the fiber is free of contamination, the process of decontaminating in some instances has introduced contamination.

In a large class of optical components, an optical fiber end is coupled with a lens so that the diverging beam exiting the optical fiber end face can be collimated and then provided to another component, such as an optical filter, attenuator or crystal, for further processing or routing. In most instances it is desirous to provide a collimated beam to such elements. Collimation of the beam can be significantly disturbed by rays that impinge on the lens in an irregular pattern, as explained below.

There have been attempts to provide lensed fibers by forming integral lenses on the end of optical fibers thereby obviating the requirement of providing a separate lens coupled to an optical fibre end. For example, U.S. Pat. No. 5,446,816 shows forming a lens at an input end of a single mode fiber by melting the end e.g. with a laser. This is known as a TEC (thermally expanded core) fiber. A problem with this approach is that the characteristics of the lens formed are not easily controlled or reproducible. In many instances, it is desirable to use a separate lens designed to provide a collimated beam that is optically coupled to an optical fiber. It has been found that using a separate lens, such as a GRIN lens is more cost effective and provides a more uniform predictable beam. The '816 patent does not place any significant emphasis on optical power density nor the coupling efficiency.

Notwithstanding, using a single mode fiber optically coupled with a GRIN lens may present reliability problems at the fiber end face when very high power light is launched from the optical fiber.

It is therefore an object of this invention to obviate this high power problem by providing a coupling arrangement that is more robust and which is relatively inexpensive to manufacture.

### SUMMARY OF THE INVENTION

In accordance with the invention there is provided an optical coupling comprising:

a monomode (single mode) optical fiber having a core and a cladding bounding the core, the monomode optical fiber fused axially to a light-transmissive optically homogeneous body (i.e. having no optical power) having a uniform refractive index and an end face opposite the core, at the distal end relative to the monomode fiber/body interface, the light-transmissive body dimensioned such that light propagating therethrough from the monomode optical fiber core diverges and passes rectilinearly therethrough to define an unobstructed cone with its base on the end face, and

a distinct lens optically coupled with the light-transmissive body for reshaping light received therefrom or light to be transmitted thereto

In one embodiment of the invention, the lens is a GRIN (graded index) lens. Alternatively, the lens may be an ordinary (e.g. spherical) lens.

The core of the monomode fiber may have a uniform refractive index no. Alternatively, the refractive index may have a variable profile, e.g. its value being highest in the center i.e. at the longitudinal axis of the core. It is the highest value of the core refractive index that is defined as no hereinafter in the present specification. In all instances, the refractive index of the core is higher than the refractive index of the cladding.

In one embodiment of the invention, the light transmissive body has a similar or substantially same diameter as the monomode optical fiber and is axially aligned therewith.

The cone may have a circular base or an elliptical base depending on the presence or absence of a slant of the end face of the transnissive body.

Further in accordance with the invention, there is provided an optical coupling comprising

an optical fiber comprising

a first waveguiding segment, the first segment having a higher refractive index core and a lower refractive index cladding bounding the core,

a second optically homogeneous light transmissive segment adjacent to the first segment, the second segment having a substantially same diameter as the first segment, an end face opposite the core of the first segment, and an outer wall, such that a diverging beam of light propagating through the second segment from the core propagates substantially unguided and unchanging in direction to the end face, the second segment being short enough in length such that the diverging beam reaches entirely the end face undisturbed i.e. without reaching the outer wall; and

a lens optically coupled with the second end segment for reshaping light received therefrom or light to be transmitted thereto.

In an embodiment of the invention, the lens is a GRIN lens.

In accordance with another aspect of the invention there is provided an optical fiber coupling capable of carrying a high power optical signal, the coupling comprising a first segment of a single mode optical fiber and a second co-axial adjacent segment of non-guiding substantially homogeneous optical fiber, the second segment forming an end of the optical fiber; and, a sleeve housing the optical fiber capable of carrying a high power optical signal, an end of the second segment and the sleeve being preferably coplanar. The end of the second segment may be coupled to a lens, for example a GRIN lens.

The second segment is distinctly separate before being fused to the first segment as opposed to forming (e.g. by heating) an integral optically homogeneous segment of an optical fiber (TEC fiber) wherein the presence of a refractive index modifying dopant is not eliminated by heating, the material is not entirely optically homogeneous and the refractive index is practically not entirely uniform.

The coupling of the invention is suitable for bidirectional passage of a light beam therethrough.

### BRIEF DESCRIPTION OF THE DRAWINGS

The invention will be explained in more details by way of the following description in conjunction with accompanying drawings in which:

FIGS. 1A-1C illustrate in a side view a method of assembling an optical fiber coupling suitable for transmitting high power optical signals,

FIGS. 1D and 1E illustrate in a side view a method of assembling another coupling, with a large beam-diverging block,

FIG. 1F is a cross-sectional view of yet another embodiment of the coupling,

FIGS. 2A-2C are side views illustrating the preparation of another embodiment of the coupling of the invention, with slanted end faces of the components,

FIG. 3 is a cross-sectional view illustrating a high-power fiber coupling of the invention mounted in a ferrule, and

FIG. 4 illustrates a coupling of the invention wherein the fiber tip is coupled with a lens.

### DETAILED DESCRIPTION OF THE INVENTION

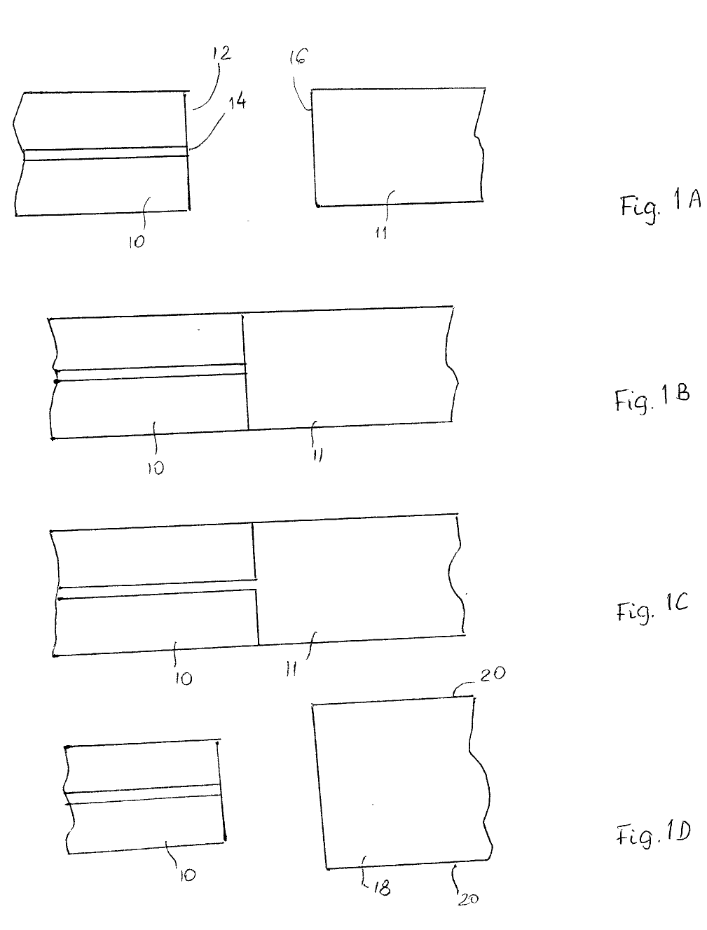

FIGS. 1A-1C show one method for preparing a termination on the end of a monomode optical fiber 10 so that it can transmit high optical powers without damaging the transmitting end face 12. This method requires a special glass optical fiber 11 having a uniform refractive index throughout equal to the refractive index of the core 14, no, of the monomode optical fiber and having the same outside diameter, d_{c}=125 μm, as the monomode fiber. This special optical fiber 11 has no core so it is not a typical optical fiber having a glass core surrounded by a glass cladding. In FIG. 1A, both the monomode fiber 10, and the special fiber 11 are shown cleaved so that the cleaved surfaces 12, 16 are at 90 degrees to the fiber axis. As shown in FIG. 1B, the two cleaved surfaces are brought into optical contact and fusion spliced together. The resulting fusion splice is shown in FIG. 1C. Note that there is no refractive index boundary in the core region between the monomode fiber 10 and the special fiber 11. Light propagating in the core 14 of the single mode fiber on reaching the special fiber 11 will no longer propagate as a bound mode but will expand, in a rectilinear manner like in a free space, in a medium having a uniform refractive index of n₀. The light will expand into a cone having a half angle α (FIG. 1E) which is known as the confinement angle for a single mode fiber and is given by α=arccos n_{c}/nₒ where n_{c} and nₒ are the refractive indices of the cladding and core respectively.

It will be noted that the light cone reaches the end face 19 of the block 18, the end face being opposite the core of the fiber 10, without reaching, and being reflected from, the side walls 20 of the block 18. This reduces or prevents the possibility of a deterioration of the light beam during subsequent processing in a lens, as will be discussed below.

The power density at the fusion interface between the monomode fiber and the special fiber can still be high, but the interface is capable of handling high optical power densities and will not deteriorate through contamination. One aspect of the invention is the recognition that the fusion splice is an optical interface capable of handling high optical powers.

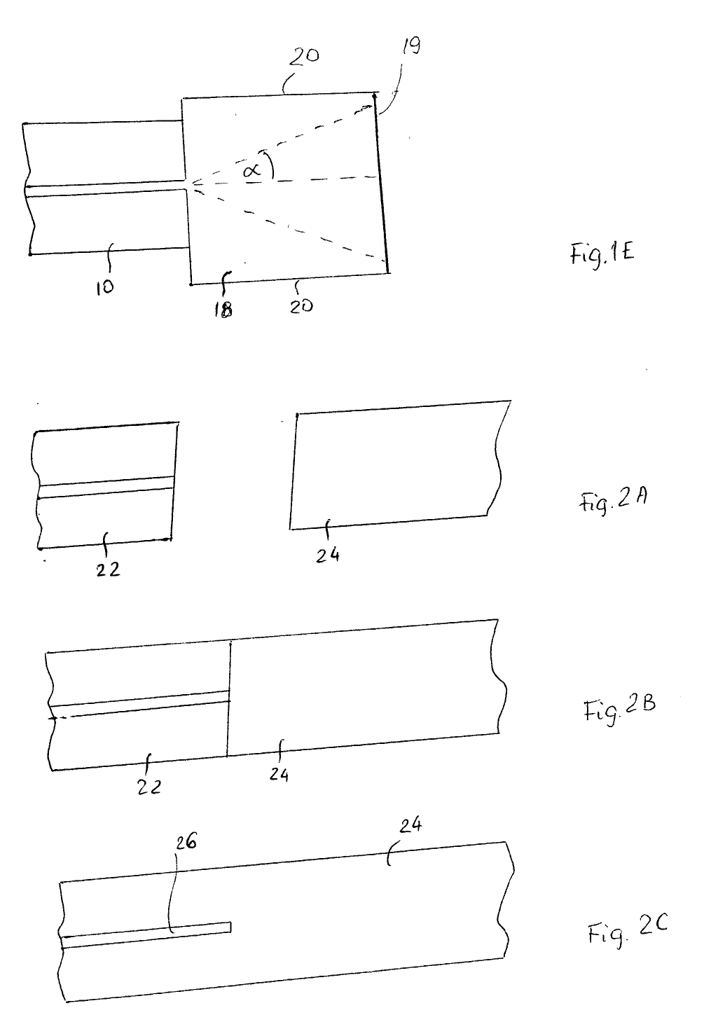

As shown in FIGS. 1D and 1E, it is possible to fuse a monomode optical fiber 10 with a light transmissive body 18 of uniform refractive index wherein the body is not limited to the same diameter as the monomode fiber. This arrangement however requires an adequate alignment procedure so that the diverging beam (shown in dashed lines in FIG. 1E) propagating in the body 18 reaches its end face 19 without contacting the side walls 20 of the body 18. As can be seen, the diverging beam thus defines an undisturbed cone with a vertex angle α (confinement angle) and with a circular base of the cone defined at end face 19. If the end face is slanted as shown in FIGS. 2A-2C, the base of the cone is elliptical.

In another embodiment of the invention, shown schematically in FIG. 1F, the monomode fiber 10 is fused with a length of a special optical fiber 11A having an enlarged core 18A and a cladding 18B. The core 18A is optically homogeneous, i.e. the refractive index of the core 18A is uniform throughout. The refractive index of the cladding 18B is lower than the refractive index of the core 18A. As in the embodiment of FIG. 1E, the refractive index of the core 18A is similar as the refractive index of the core 14 of the monomode fiber 10.

The dimensions of the special fiber 11A are selected so that light emitted from the core 14 diverges and propagates unobstructed to the end face 21 of the special fiber 11A, defining an undisturbed cone, without contacting the outside wall of the optically homogeneous body, the wall defined by the interface between the core 18A and the cladding 18B. The beam defines a confinement angle α similarly as in FIG. 1E.

The absence of disruption of the beam cone is important for the purposes of the invention as it is preferable that the diverging beam after passing through the end face 19 or 21 is incident on a lens in a regular pattern, free of spurious angles of incidence.

FIGS. 2A-2C show another method of preparing the end of the monomode fiber 22 so that it can handle high optical power densities. In this case, the special fiber 24 has a refractive index n_{c}=1.46 corresponding to the refractive index of the silica cladding of the monomode optical fiber. The advantage of using a fiber made of fused silica is that it is more readily obtainable than a special fiber having the same refractive index as the core of the monomode fiber. Again, this special fiber 24 has an outside diameter of 125 μm (like the monomode fiber 20) and no core. As shown in FIG. 2A, the ends of the monomode fiber and the special fiber are cleaved at an angle of about 82-84 degrees to the fiber axis. The ends of the monomode fiber and the special fiber are brought into optical contact as shown in FIG. 2B and fusion spliced together. The resulting structure is shown in FIG. 2C. Note that the refractive index boundary between the monomode fiber cladding and the special optical fiber has disappeared. There is still an index boundary between the fiber core 26 and the special fiber 24. This boundary is at the above angle (82-84°) to the longitudinal fiber axis thereby preventing the backscattered light from coupling back into the monomode fiber.

For one skilled in the art, other methods for fabricating the interfaces depicted in FIGS. 1A-1F and 2A-2C are conceivable. For example, the end of a monomode fiber can in some instances be heated in a controlled manner and have the core disappear (the above-mentioned TEC approach, which appears inferior to the approach described herein). Alternatively, a special monomode fiber may be fabricated that has a photosensitive cladding. Upon radiation of this special fiber with actinic radiation, for example ultraviolet light, the refractive index of the cladding is increased to match the refractive index of the core. By this means a fiber end can be prepared which has no core for guiding the light in the region that was radiated.

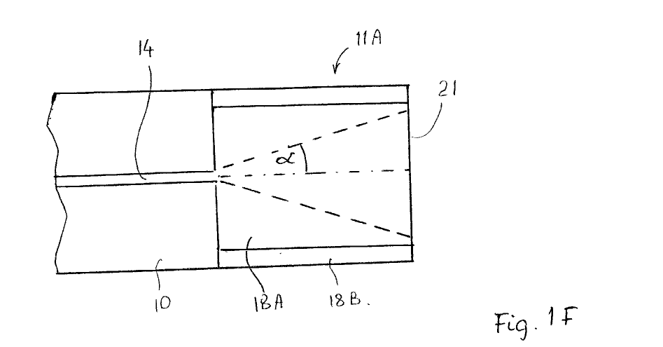

FIG. 3 shows incorporating of the monomode fiber/special fiber interface into a high power fiber tip. The monomode fiber/special fiber interface prepared using either the methods shown in FIGS. 1A-1F or in FIGS. 2A-2C is inserted into a glass ferrule 30 having a hole with a diameter corresponding to the diameter of the optical fibers, i.e. 125 μm. The fusion interface is inserted into the ferrule 30 so that it is a distance L from the end of ferrule as shown in FIG. 3. The portion of the special fiber that projects out the end of the ferrule is cut and the glass ferrule end and fiber end may be polished with the polished surface having a nominal angle β of about 8-6 degrees to the vertical or 82-84 degrees to the fiber axis. Light propagating in the monomode fiber 10 on reaching the fusion interface will expand in the glass medium of the special fiber 11. The expansion is in the form of a cone having a half angle α (FIG. 1E). On reaching the end of the special fiber, the beam diameter will have expanded to have a diameter D, as indicated in FIG. 3. The size of D will depend on the length L. The relation between D and L can be readily determined to be

$$L \leq \frac{{n}_{c}}{2 \sqrt{{n}_{o}^{2} - {n}_{c}^{2}}} D .$$

As the divergent conical beam should not touch the side walls of the special fiber (the side walls defining the boundary of the optically homogeneous, uniform refractive-index body), the above relationship defines the maximum acceptable value of L.

In the case that n_{c}=1.46 and nₒ=1.47, L=4.26 D. Since the expanding cone of light should not be incident on the sides of the special fiber, D is limited to being less than 125 μm, which places a corresponding limitation on L<533 μm. Because of the expansion in beam size that occurs in the special fiber region, the optical power density at the special fiber/air interface of the fiber tip is lower. For example, to decrease the power density from that in the single mode fiber by a factor of 25, the beam diameter D should be about 5 times the diameter of the core of the monomode fiber which has a typical value of 9 μm. For D to have a value of 45 μm, the length L must be 191 μm.

In practice, the coupling should be dimensioned such that the power density at the end face of the second segment, or the light transmissive body, either a special fiber 11 or a body 18, be at least ten times lower than the power density of the light propagating through the first segment i.e. in the core of the optical fiber 10.

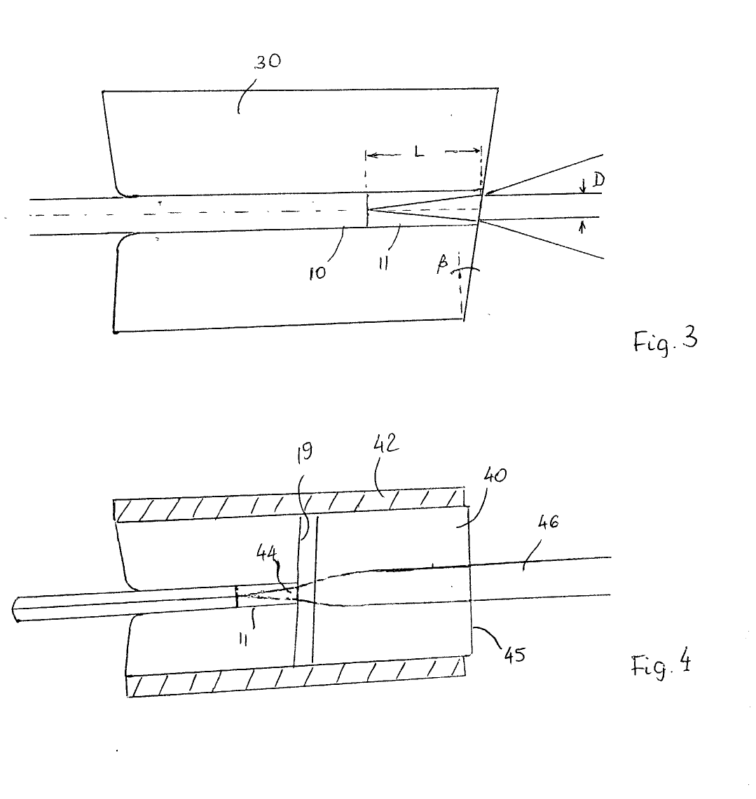

FIG. 4 shows another embodiment of the invention in which the fiber tip of FIG. 3 is incorporated with a GRIN lens 40 to make an integrated unit that produces a collimated beam and is capable of handing high optical powers. As known, the GRIN lens 40 is mounted in a tube 42 at a small spacing from the fiber tip, and is slanted at a small angle corresponding to the slant of the fiber tip as described above, to reduce backreflections. It is preferable for producing a collimated beam in the GRIN lens that the conical shape of the divergent beam 44 in the second segment 11 is not disturbed by the conical beam contacting the outside cylindrical wall of the segment 11 before entirely reaching the end face 19 of the segment 11. Such contact with the outside wall would likely produce spurious reflections and irregular incidence angles on the input surface of the GRIN lens 40. FIG. 4 illustrates a desirable optical arrangement with a properly collimated beam 46 exiting the GRIN lens 40.

For the purpose of the invention, an approximately quarter-wave GRIN lens is suitable. The outside surface 45 of the GRIN lens is preferably coated with an antireflective (AR) coating.

Numerous other embodiments of the invention are conceivable without departing from the scope and spirit of the invention as defined by the appended claims.

What is claimed is:

1. An optical coupling comprising:
a monomode optical fiber having a core and a cladding bounding the core, the optical fiber fused axially to a light-transmissive optically homogeneous body having a uniform refractive index and an end face opposite the core, the body dimensioned such that light propagating therethrough from the optical fiber core diverges and passes rectilinearly through the optically homogeneous body to define an unobstructed cone with its base on the end face, and
a distinct lens optically coupled with the light-transmissive body for reshaping light received therefrom or light to be transmitted thereto.

2. The optical coupling according to claim 1 wherein the lens is a graded index lens.

3. The optical coupling according to claim 1 wherein the length L of the light-transmissive body meets the following relationship
$$L \leq \frac{{n}_{c}}{2 \sqrt{{n}_{o}^{2} - {n}_{c}^{2}}} D$$
wherein D is a diameter of the body, no is the refractive index of the core of the optical fiber and n_{c} is the refractive index of the cladding of the optical fiber.

4. The optical coupling of claim 1 wherein the light transmissive body has a similar or substantially same diameter as the optical fiber and is axially aligned with the optical fiber.

5. The optical coupling of claim 1 wherein the end face is slanted to reduce backreflections.

6. The optical coupling of claim 1 wherein the refractive index of the light transmissive body is equal to the refractive index of the core of the monomode fiber.

7. The optical coupling of claim 1 wherein the refractive index of the light transmissive body is equal to the refractive index of the cladding of the monomode fiber.

8. An optical coupling comprising:
an optical fiber having
a first waveguiding segment, the first segment having a higher refractive index core and a lower refractive index cladding bounding the core, and
a light transmissive second segment axially fused to the first segment, the second segment having a substantially same diameter as the first segment and a uniform refractive index, substantially no optical power and substantially no mode shaping characteristics, such that a diverging beam of light propagating therethrough, propagates substantially unguided and unchanging in direction, the second segment having an end face and being short enough in length such that diverging light propagating therethrough from the core of the first segment reaches the end face without reaching an outer wall of the second segment as it passes completely through the second segment, and
a lens optically coupled with the second end segment for reshaping light received therefrom or light to be transmitted thereto.

9. An optical fiber coupling capable of carrying a high power optical signal, the coupling comprising a first segment of a monomode optical fiber, a second axially aligned adjacent segment of non-guiding substantially homogenous optical fiber, the second segment forming an end of the optical fiber; and, a sleeve housing the optical fiber capable of carrying the high power optical signal.

10. An optical fiber coupling as defined in claim 9 further comprising a lens optically coupled to the end of the second segment.

11. An optical fiber coupling as defined in claim 1, wherein the power density of the light at the end face of the second segment is at least ten times less the power density of the light propagating through the first segment.
